(19) United States
(12) Patent Application Publication
(10) Pub. No.: US 2014/0127575 A1
(43) Pub. Date: May 8, 2014

(54) POSITIVE ACTIVE MATERIAL FOR LITHIUM SULFUR BATTERY AND LITHIUM SULFUR BATTERY COMPRISING SAME

(71) Applicant: INDUSTRY-UNIVERSITY COOPERATION FOUNDATION HANYANG UNIVERSITY, (US)

(72) Inventors: BRUNO SCROSATI, Roma (IT); Yang Kook SUN, Seoul (KR); JUNG HOON KIM, Gyeonggi-do (KR); HUN-GI JUNG, Busan (KR); JUSEF HASSOUN, Latina (IT)

(73) Assignee: INDUSTRY-UNIVERSITY COOPERATION FOUNDATION HANYANG UNIVERSITY, Seoul (KR)

(21) Appl. No.: 13/860,042

(22) Filed: Apr. 10, 2013

(30) Foreign Application Priority Data
Nov. 6, 2012 (KR) 10-2012-0124891

(51) Int. Cl. H01M 4/36

(52) U.S. Cl. CPC H01M 4/366
USPC 429/213; 429/231.8

(57) ABSTRACT

The present invention relates to a positive active material for a lithium sulfur battery and a lithium sulfur battery comprising the same, and the positive active material for a lithium sulfur battery comprises a core comprising Li₂S and a carbon layer formed on the surface of the core.

### FIELD OF THE INVENTION

The present disclosure relates to a positive active material for a lithium sulfur battery and a lithium sulfur battery comprising the same.

### BACKGROUND OF THE INVENTION

Recently, the use of mobile electronic devices is increasing according to reduction in weight and size of electronic devices by development of high-tech electronics industries. Accordingly, the demand for batteries having high energy density as energy sources of these mobile electronic devices has increase, and therefore, studies for the lithium secondary batteries are actively proceeding.

As the lithium secondary batteries, there are lithium ion batteries, lithium-sulfur batteries, lithium-air batteries and the like, and studies for improving energy density, safety and the like of the lithium secondary battery are continuously required. For example, in transition insertion chemistry, studies for innovative conversion system are proceeding, and one of them is lithium sulfur system. The lithium sulfur system, based on the reaction 16Li+S₈→8Li₂S, is a system generating very higher energy (2,500 Whkg⁻¹) than the conventional lithium ion battery (500 Whkg⁻¹).

However, because the lithium sulfur battery has problems of limited cycle life due to dissociation of sulfur in the positive electrode, bad safety due to reactivity of a lithium metal negative active material, and bad rate characteristic due to bad electric conductivity of the positive active material, it is not practically applied.

### SUMMARY OF THE INVENTION

One embodiment of the present invention is to provide a positive active material for a lithium sulfur battery having excellent cycle life.

Another embodiment of the present invention is to provide a lithium sulfur battery comprising the positive active material.

According to one embodiment of the present invention, the present invention provides a positive active material for a lithium sulfur battery comprising: a core comprising Li₂S; and a carbon layer formed on the surface of the core.

The carbon layer is formed with thickness of 10 nm to 500 nm. Further, the amount of the carbon layer is 20 wt % to 70 wt %, based on the weight of the core comprising Li₂S.

In one embodiment of the present invention, the carbon layer is formed with a carbon derived from a carbon precursor selected from sucrose, glucose, pitch, polyvinylpyrrolidone, polyacrylonitrile, or a combination thereof.

According to another embodiment of the present invention, the present invention provides a lithium sulfur battery comprising: a positive electrode comprising the positive active material; a negative electrode comprising a negative active material; and an electrolyte.

Details of the further other embodiments of the present invention are included in the following detailed description.

### Advantageous Effects of the Invention

The positive active material for a lithium sulfur battery of the present invention is excellent on cycle life.

### BRIEF DESCRIPTION OF DRAWINGS

The above and other objects and features of the present invention will become apparent from the following description of the invention taken in conjunction with the following accompanying drawings, which respectively show:

FIG. 1: a graph measuring X-ray diffraction pattern of the positive active material and the isolated positive electrode, manufactured according to Example 2 using CuKα;

FIG. 2: a graph measuring X-ray diffraction pattern of the positive electrode and isolated electrode manufactured according to Comparative Example 1 using CuKα;

FIG. 3: graph showing charging/discharging of the lithium sulfur battery manufactured according to Example 3;

FIG. 4: a graph showing charging/discharging characteristic of the lithium sulfur battery manufactured according to Example 4; and

FIG. 5: a graph showing cycle life of the lithium sulfur battery manufactured according to Example 5.

### DETAILED DESCRIPTION OF THE INVENTION

Hereinafter, embodiment of the present invention now will be described in detail. The embodiments are illustrative purposes only and are not to be construed to limit the scope of the present invention as defined in the following claims.

One embodiment of the present invention provides a positive active material for a lithium sulfur battery comprising: a core comprising Li₂S; and a carbon layer formed on the surface of the core.

The thickness of the carbon layer may be 10 nm to 500 nm, and preferably, 20 nm to 100 nm. When the thickness of the carbon layer is within the range, in the battery comprising the positive active material, electric conductivity of Li₂S, electrically non-conductor, will be improved, and direct contact of an electrolyte to an organic solvent can be prevented, thereby effectively inhibiting dissolution of the electrolyte in the organic solvent. Further, direct contact of the Li₂S to an organic solvent used for manufacturing a positive active material layer can be prevented. Therefore, by using the Li₂S, a positive active material layer can be formed through a casting process. When the Li₂S compound is applied to the positive electrode of a lithium sulfur battery, it is not needed to use a lithium metal as the negative electrode because it contains a lithium source, and therefore, a lithium sulfur battery having high safety can be manufactured. However, in spite of the said advantage, a positive active material layer could not be formed by a common casting process using the Li₂S compound because it was dissolved in the organic solvent used for manufacturing the positive active material layer, particularly N-methylpyrrolidone. Accordingly, it was difficult to apply the Li₂S compound as the positive active material.

In one embodiment of the present invention, the positive active material layer can be formed through a common casting process because direct contact of the Li₂S to the organic solvent such as N-methylpyrrolidone can be prevented, and the reaction of the Li₂S with the said solvent can be inhibited by using the Li₂S as a core and forming the carbon layer on the surface of the core. Further, by forming the carbon layer on the core containing the Li₂S, electric conductivity of the entire positive active material layer can be improved and the contact with the electrolyte can be more effectively inhibited at the same time, compared with the case forming the positive active material layer containing the Li₂S followed by forming the carbon layer separately on the positive active material layer.

Further, when charging/discharging the lithium sulfur battery comprising the Li₂S positive active material, there may be an intermediated in the form of lithium polysulfite on the way of charging/discharging of the Li₂S positive active material to S₈, and the intermediate is dissolved in the electrolyte thereby breaking down the electrode structure. Accordingly, there may be a problem of reduction of capacity retention rate, but the positive active material according to one embodiment of the present invention, which contains the carbon layer on the surface thereof, can solve the problem. Further, the effect of inhibiting the capacity retention rate reduction by comprising the carbon layer on the surface of the positive active material is an effect barely obtained from the positive active materials such as lithium cobalt-based oxides used for a lithium secondary battery. The reason is that the problem of breakdown of the electrode structure by the dissolved positive active material in the electrolyte, when charging/discharging the active material used for a lithium secondary battery such as lithium cobalt-based oxide, is very rare.

Average size of the core may be about 5 μm or less, and preferably, 1 μm to 5 μm. When the average size of the core is within the said range, there may be advantages of preventing agglutination of Li₂S powers during carbon coating, and forming a uniform carbon coated layer.

In one embodiment of the present invention, the amount of the carbon layer may be 20 wt % to 70 wt %, based on the total weight of the core comprising the Li₂S. When the amount of the carbon layer is within the range, the carbon layer can be formed around the core with proper thickness. Therefore, the electrolyte can be prevented from contacting with the organic solvent, and there may be an advantage of improving electric conductivity.

The carbon layer is formed with a carbon derived from a carbon precursor selected from sucrose, glucose, pitch, polyvinylpyrrolidone, polyacrylonitrile, or a combination thereof.

The carbon of the carbon layer, which is formed from the carbon precursor, may include an amorphous carbon, a crystalline carbon or a combination thereof.

The positive active material according to one embodiment of the present invention having the said constitution can be manufactured by: mixing the core comprising the Li₂S with the carbon precursor in a solvent, drying the mixture in a vacuum oven of 60° C. to 100° C. for 12 hrs or more, specifically for 12 hrs to 24 hrs, and heating the dried mixture under argon or nitrogen atmosphere at a temperature of 650° C. to 800° C. for 1 hr to 10 hrs. When the heating process is performed within the said temperature range, a more complete carbon layer can be formed without a problem of Li₂S degradation. When S₈ is used as a core instead of the Li₂S, it may be entirely evaporated during the heating process. Accordingly, the process can't be used, and thereby, the effect according to the carbon layer formation can't be obtained.

The mixing ratio of the Li₂S and the carbon precursor may be 1:0.5 to 1:10. When the mixing ratio of the Li₂S and the carbon precursor is within the said range, the carbon layer is piled up around the Li₂S particles enough to be formed with a proper thickness, but not too thick to cause performance deterioration by inhibiting transfer of the lithium ions.

The solvent may be N-methylpyrrolidone, tetrahydrofuran, hexane or a combination thereof.

Another embodiment of the present invention provides a lithium sulfur battery comprising the positive electrode containing the positive active material; the negative electrode containing the negative active material; and an electrolyte.

In the lithium sulfur battery according to one embodiment of the present invention, the positive electrode comprises a positive active material layer containing the positive active material. The amount of the positive active material may be 80 wt % to 98 wt %, based on the total weight of the positive active material layer.

The positive active material layer comprises a binder and a conducting material. At this time, the amounts of the binder and the conducting material may be 1 wt % to 10 wt %, respectively, based on the total weight of the positive active material layer.

The conducting material contains an electron conductive material, which enables electrons to smoothly transfer in the positive electrode. The conducting material is not particularly limited, but it may be preferably conducting material such as a graphite-based material and a carbon-based material, or a conductive polymer. The graphite-based material may be KS 6 (product of Timcal), and the carbon-based material may be Super P (product of MMM), Ketjen black, denca black, acetylene black, carbon black and the like. The conductive polymer may be polyaniline, polythiophen, polyacetylene, polypyrrole and the like. These conductive conducting materials may be used alone or in combination of two or more.

As the binder, polyethylene oxide, polyvinyl pyrrolidone, poly(methyl methacrylate), polyvinylidene fluoride, copolymer of polyhexafluoropropylene and polyvinylidene fluoride (product name: Kynar), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives blends or copolymer thereof can be used.

Further, the positive electrode is a current collector supporting the positive active material layer, and as the positive electrode, conductive materials such as stainless steel, aluminum, copper and titanium can be used, but not limited thereto. Particularly, as the current collector, a carbon-coated aluminum collector can be properly used. There are advantages by using this carbon-coated aluminum collector that adhesive strength to the active material is excellent, the contact resistance is low, and the corrosion of aluminum by polysulfide can be prevented, compared with using a collector not coated with carbon.

The positive electrode having the said constitution can be manufactured according to the following processes.

The positive active material, the binder and the conducting material are added to the solvent to prepare a slurry type positive active material composition. At this time, the solvent may be any one, which can disperse the positive active material, the binder, the conducting material and additives homogeneously, and can be easily evaporated, and representatively, it may be N-methylpyrrolidone, acetonitrile, methanol, ethanol, propanol, butanol, tetrahydrofuran, water, isopropyl alcohol, dimethylpyrrolidone and the like.

The prepared composition is coated on the current collector and dried to form the positive electrode.

The negative electrode contains the negative active material. The negative active material may be selected from the group consisting of: a material, which can reversibly intercalate or deintercalate the lithium ions; a material, which can reversibly form a lithium-containing compound by reacting with the lithium ions; lithium metal; and lithium alloy. Further, the negative electrode may contain a negative active material comprising the negative active material and a current collector supporting thereof. The current collector may be selected from the group consisting of: copper foil, nickel foil, stainless steel foil, titanium foil, nickel foam, copper foam, polymer substrate coated with conductive metal, and a combination thereof.

The material, which can reversibly intercalate or deintercalate the lithium ions, may be any carbon material, preferably any carbon-based negative active material, which is generally used for a lithium battery, and its representative example may be crystalline carbon, amorphous carbon or a combination thereof. Further, the material, which can reversibly form a lithium-containing compound by reacting with the lithium ions, may be representatively tin oxide (SnO₂), titanium nitrate, silicon (Si) and the like, but not limited thereto. The lithium alloy may be an alloy of lithium and metal selected from the group consisting of: Na, K, Rb, Cs, Fr, Be, Mg, Ca, Sr, Ba, Ra, Al and Sn.

A material, wherein an inorganic protective layer, an organic protective layer or both of them are laminated on the lithium metal surface, can be used as the negative electrode. The inorganic protective layer may contain a material selected from the group consisting of: Mg, Al, B, C, Sn, Pb, Cd, Si, In, Ga, lithium silicate, lithium borate, lithium phosphate, lithium phosphornitride, lithium silicosulfide, lithium borosulfide, lithium aluminosulfide and lithium phosphosulfide. The organic protective layer may contain a conductive monomer, oligomer or polymer selected from the group consisting of: poly(p-phenylene), polyacetylene, poly(p-phenylene vinylene), polyaniline, polypyrrole, polythiophen, poly(2,5-ethylene vinylene), acetylene, poly(perinaphthalene) and polyacene and poly(naphthalene-2,6-diyl).

The lithium secondary battery according to one embodiment of the present invention, which uses the positive active material having the carbon layer, can use an electrolyte generally used for a lithium ion battery (generally expressed as a lithium secondary battery) as well as an electrolyte generally used for a lithium sulfur battery as an electrolyte.

The electrolyte for a lithium sulfur battery contains an organic solvent and a lithium salt, and at this time, the organic solvent may be a single solvent or a mixture of two or more organic solvents. When using the mixture of two or more organic solvents, it is preferred to use at least one solvent selected from two or more groups, which are selected from a weak polar solvent group, a strong polar solvent group and a lithium metal protecting solvent group.

The weak polar solvent is defined as a solvent having dielectric constant of less than 15, which is selected from aryl compound, bicyclic ether and acyclic carbonate, and also can dissolve a sulfur atom; the strong polar solvent is defined as a solvent having dielectric constant of more than 15, which is selected from acyclic carbonate, sulfoxide compound, lactone compound, ketone compound, ester compound, sulfate compound, sulfite compound, and also can dissolve lithium polysulfide; and the lithium protecting solvent is defined as a solvent, which has charging/discharging cycle efficiency of 50% or more, and forms a lithium metal stable-SEI (Solid Electrolyte Interface) film, such as saturated ether compound, unsaturated ether compound, heterocyclic compound containing N, O, S or a combination thereof.

Specifically, the weak polar solvent may be xylene, dimethoxyethane, 2-methyltetrahydrofuran, diethyl carbonate, dimethyl carbonate, toluene, dimethyl ether, diethyl ether, diglyme, tetraglyme and the like.

Specifically, the strong polar solvent may be hexamethyl phosphoric triamide, gamma-butyrolactone, acetonitrile, ethylene carbonate, propylene carbonate, N-methylpyrrolidone, 3-methyl-2-oxazolidone, dimethyl formamide, sulfolane, dimethyl acetamide or dimethyl sulfoxide, dimethyl sulfate, ethylene glycol diacetate, demethyl sulfite, ethylene glycol sulfite and the like.

Specifically, the lithium protecting solvent may be tetrahydrofuran, dioxolane, 3,5-dimethyl isoxazole, 2,5-dimethyl furan, furan, 2-methyl furan, 1,4-oxane, 4-methyldioxolane and the like.

The lithium salt may be at least one of lithium trifluoromethansulfonimide, lithium triflate, lithium perclorate, LiPF₆, LiBF₄, tetraalkylammonium such as tetrabutylammonium tetrafluoroborate (TBABF₄), or a salt, which is liquid at room temperature, for example imidazolium salt such as 1-ethyl-3-methylimidazolium bis-(perfluoroethyl sulfonyl)imide (EMIBeti). At this time, the concentration of the lithium salt may be preferably within the range of 0.6 to 2.0 M, and more preferably within the range of 0.7 to 1.6 M. When the concentration of the lithium salt is within the range, proper viscosity of the electrolyte can be maintained, and thereby the lithium ions can transfer well while maintaining performance of the electrolyte.

Further, the electrolyte for a lithium ion battery contains a non-aqueous organic solvent and a lithium salt, and the non-aqueous organic solvent plays a role of a medium where ions, participated in electrochemical reaction of the battery, can transfer.

The non-aqueous organic solvent may be a carbonate-based, ester-based, ether-based, ketone-based, alcohol-based, or aprotic solvent. The carbonate-based solvent may be dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC) and the like; and the ester-based solvent may be methyl acetate, ethyl acetate, n-propyl acetate, dimethyl acetate, methylpropionate, ethylpropionate, γ-butyrolactone, decanolide, valerolactone, mevalonolactone, caprolactone and the like. The ether-based solvent may be dibutyl ether, tetraglyme, diglyme, dimethoxyethane, 2-methyltetrahydrofuran, tetrahydrofuran and the like; and the ketone-based solvent may be cyclohexanone and the like. Further, the alcohol-based solvent may be ethylalcohol, isopropyl alcohol and the like, and the aprotic solvent may be nitriles such as R—CN (wherein, R is a hydrocarbon group with a carbon number of 2 to 20 having a linear, branched or cyclic structure, and may include a double-bonded aromatic ring or an ether bond), amides such as dimethylformamide, dioxolanes such as 1,3-dioxolane, sulfolanes and the like.

A single or a mixture of one or more non-aqueous organic solvents may be used, and when the mixture of one or more non-aqueous solvents is used, the mixing ratio may be properly adjusted according to the targeted battery performance and the adjustment is understood by those of ordinary skill in the art.

Further, in the case of the carbonate-based solvent, it is preferred to use a mixture of cyclic carbonate and chain carbonate. At this time, the cyclic carbonate and the chain carbonate can be mixed to the volume ratio of 1:1 to 1:9 so as to obtain excellent performance of the electrolyte.

The non-aqueous organic solvent of the present invention may further comprise an aromatic hydrocarbon-based organic solvent together with the carbonate-based solvent. At this time, the carbonate-based solvent and the aromatic hydrocarbon-based organic solvent may be mixed at the volume ratio of 1:1 to 30:1.

The aromatic hydrocarbon-based organic solvent may be an aromatic hydrocarbon-based compound of the following chemical formula 1.

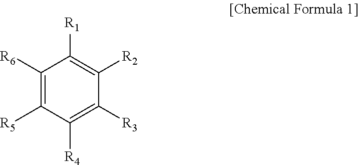

(wherein, R₁ to R₆ are identical or different each other, and selected from the group consisting of: hydrogen, halogen, an alkyl group with a carbon number of 1 to 10, a haloalkyl group with a carbon number of 1 to 10 and a combination thereof.)

Specifically, the aromatic hydrocarbon-based organic solvent may be selected from the group consisting of: benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

In order to improve battery life, the non-aqueous electrolyte may further comprise vinylene carbonate or an ethylene carbonate-based compound of the following chemical formula 2.

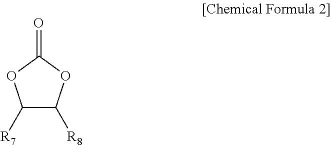

(wherein. R₇ and R₈ are identical or different each other, selected from the group consisting of: hydrogen, a halogen group, a cyano group (CN), a nitro group (NO₂) and a fluorinated alkyl group with a carbon number of 1 to 5, and at least one of the R₇ and R₈ is selected from the group consisting of a halogen group, a cyano group (CN), a nitro group (NO₂) and a fluorinated alkyl group with a carbon number of 1 to 5, but none of the R₇ and R₈ is hydrogen.) Representatively, the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate and the like. When further using additives for improving life, the amount used can be properly adjusted.

The lithium salt is dissolved in the organic solvent, enables the basic operation of the lithium secondary battery by acting as a source of lithium ions in the battery, and is a material for promoting the transfer of lithium ions between the positive electrode and the negative electrode. For example, the lithium salt may include at least one supporting electrolytic salt selected from the group consisting of: LiPF₆, LiBF₄, LiSbF₆, LiAsF₆, LiN(SO₂C₂F₅)₂, Li(CF₃SO₂)₂N, LiN(SO₃C₂F₅)₂, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI and LiB(C₂O₄)₂ (lithium bis(oxalato) borate; LiBOB). The concentration of the lithium salt may be within the range of 0.1 to 2.0 M, preferably. When the concentration of the lithium salt is within the said range, the electrolyte can have appropriate conductivity and viscosity. Therefore, good electrolyte performance may be obtained and the lithium ions may be effectively transferred.

In one embodiment of the present invention, the electrolyte may be a solid polymer electrolyte. The polymer electrolyte contains lithium salts, Li₂S and polymer.

The polymer may be selected from the group consisting of: polyethyleneoxide, polypropyleneoxide, polyacrylonitrile, polyvinylidene fluoride and a combination thereof. Weight average molecular weight (Mw) of the polymer may be 200,000 to 600,000.

The lithium salts may be identical or different each other, and preferably may be selected from the group consisting of: LiCF₃SO₃, LiPF₆, LiClO₄, LiBF₄, LiB(C₂O₄), LiN(SO₂F)₂, LiN(SO₂CF₃)₂, LiN(SO₂C₂F₃)₂, LiCF₆SO₃ and a combination thereof.

The molar ratio of the polymer, the lithium salt and the Li₂S may be 15 to 25:1 to 2:1.

Hereinafter, Examples and Comparative Example will be described. The Examples are presented for illustrative purposes only, and do not limit the present invention.

### EXAMPLE 1

Li₂S and a pitch carbon precursor was mixed in N-methylpyrrolidone solvent at weight ratio of 1:3. The mixture was dried at a vacuum oven of 60° C. for 12 hrs to obtain a completely dried mixture. The obtained mixture was heat-treated at 750° C. argon atmosphere for 3 hrs to prepare a positive active material coated with a carbon layer on the Li₂S core surface. The thickness of the carbon layer was 40 nm, and the amount of the carbon layer was 70 wt %, based on the weight of the Li₂S core.

The positive active material in an amount of 80 wt %, Super P and KS 6 conducting materials in an amount of 5 wt %, respectively, and polyvinylidene fluoride binder in an amount of 10 wt % were mixed in N-methylpyrrolidone solvent to prepare a positive active material slurry. The positive active material slurry was coated on an Al current collector and dried to manufacture the positive electrode.

### EXAMPLE 2

Li₂S and a pitch carbon precursor were mixed in N-methylpyrrolidone solvent at weight ratio of 1:3. The mixture was dried at a vacuum oven of 60° C. for 12 hrs to obtain a completely dried mixture. The obtained mixture was heat-treated at 750° C. argon atmosphere for 7 hrs to prepare a positive active material coated with a carbon layer on the Li₂S surface. The thickness of the carbon layer was 40 nm, and the amount of the carbon layer was 70 wt %, based on the weight of the Li₂S core.

The positive active material in an amount of 80 wt %, Super P and KS 6 conducting materials in an amount of 5 wt %, respectively, and polyvinylidene fluoride binder in an amount of 10 wt % were mixed in N-methylpyrrolidone solvent to prepare a positive active material slurry. The positive active material slurry was coated on an Al current collector and dried to manufacture the positive electrode.

### COMPARATIVE EXAMPLE 1

Li₂S in an amount of 80 wt %, Super P and KS 6 conducting materials in an amount of 5 wt %, respectively, and polyvinylidene fluoride binder in an amount of 10 wt % were mixed in N-methylpyrrolidone solvent to prepare a positive active material slurry, and the positive active material slurry was coated on an Al current collector and dried to manufacture the positive electrode.

* X-Ray Diffraction Pattern Measurement

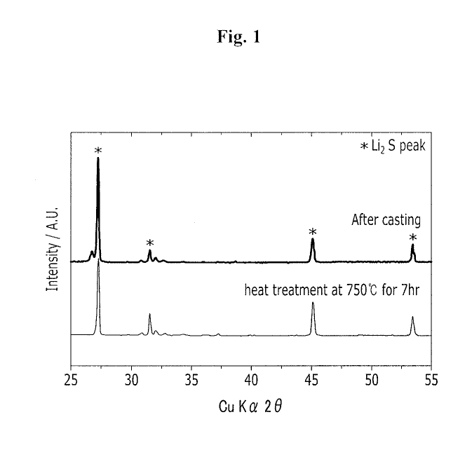

X-ray diffraction pattern of the positive active material manufactured according to Example 2 was measured by using CuKα. Further, the positive electrode manufactured according to Example 2 was isolated and X-ray diffraction pattern of the isolated positive electrode was measured by using CuKα. The results were shown in FIG. 1.

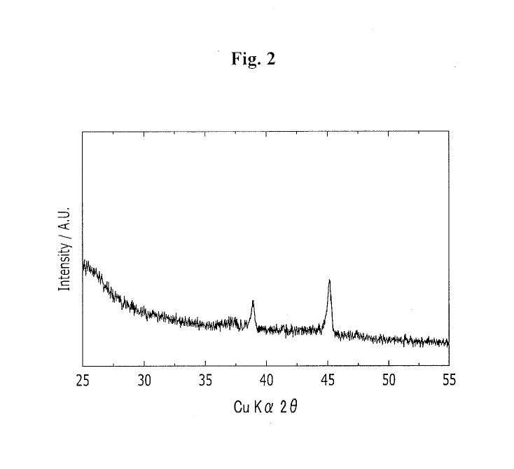

Further, the positive electrode manufactured according to Comparative Example 1 was isolated from the positive electrode, and X-ray diffraction pattern of the isolated positive electrode was measured by using CuKα. The results were shown in FIG. 2.

As shown in FIG. 1, in the case of the positive active material manufactured according to Example 2, it could be found that Li₂S peak was maintained as it was although the N-methylpyrrolidone solvent was used for manufacturing the positive active material slurry, but as shown in FIG. 2, it could be found that Li₂S peak was not shown in Comparative Example 1. From the results of FIG. 1 and FIG. 2, in the positive active material of Example 2, wherein the carbon layer was formed on the Li₂S surface, the carbon layer inhibited direct contact of the Li₂S and external moisture when manufacturing the slurry, thereby maintaining the structure as it is, but the positive active material of Comparative Example 1 simply mixing the Li₂S and the carbon could not maintain the structure because the Li₂S was decomposed by direct contact of the Li₂S and the external moisture.

### EXAMPLE 3

A lithium sulfur battery was manufactured by using the lithium metal negative electrode, the positive electrode manufactured in Example 2 and an electrolyte solution by a common method. As the electrolyte solution, a mixed solvent of 1.0 M LiPF₆-dissolved ethylene carbonate and dimethyl carbonate (3:7 volume ratio) was used.

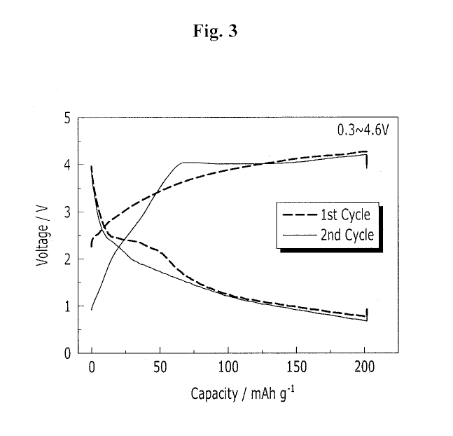

Charging/discharging characteristic of the lithium sulfur battery manufactured in Example 3 was measured by charging/discharging thereof two times at 0.3 V to 4.6 V with current of 30 mA/g. The results were shown in FIG. 3, and the results of measuring charging/discharging capacity were shown in the following Table 1.

TABLE 1

| | Charge | Discharge |
|---|---|---|
| Cycle Number | Capacity (mAh/g) | Capacity (mAh/g) |
| 1^{st} | 201.8 | 201.8 |
| 2^{nd} | 201.8 | 201.8 |

As shown in Table 1 and FIG. 3, it could be found that the lithium sulfur battery manufactured according to Example 3, which used the carbonate-based electrolyte, worked as a battery. From this result, it could be found that, when the Li₂S core, in which the carbon layer is formed, can be used as a positive active material, the electrolyte used for a lithium ion battery can be used.

### EXAMPLE 4

Polyethyleneoxide (weight average molecular weight: 6×10⁵), LiCF₃SO₃ and Li₂S were dried, aliquoted, and put into a sealed polyethylene bottle at an accurate ratio. At this time, the mixing molar ratio of the polyethyleneoxide, the LiCF₃SO₃ and the Li₂S were 20:1:1. The bottle was completely mixed by using soft glass ball-milling for 24 hours to obtain a homogeneous power mixture. In order to prevent air contamination, all processes were performed in an argon atmosphere dry box.

The powder mixture was first pressed at 90° C. with pressure of 0.5 ton for 15 min, and then second pressed at 90° C. with pressure of 4 ton for 60 min to form a uniform and rigid polymer electrolyte with the thickness of 150 μm.

A lithium sulfur battery was manufactured by using the polymer electrolyte, the positive electrode manufactured in Example 2 and the negative electrode manufactured in Example 3 by a common method.

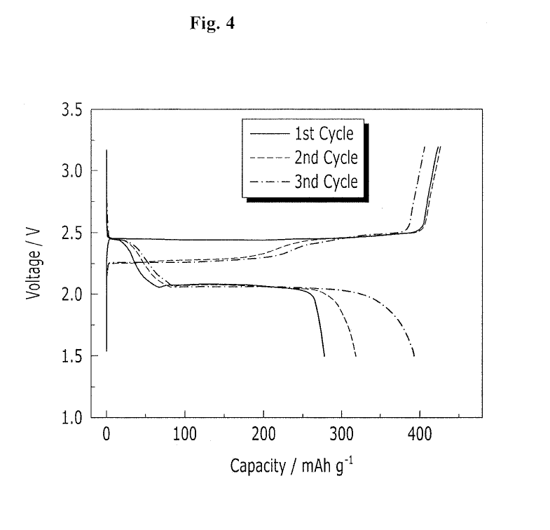

The lithium sulfur battery manufactured in Example 4 were charged/discharged three times at a temperature of 70° C. and 0.3 V to 4.6 V with current of 30 mA/g. The measured charging/discharging characteristic was shown in FIG. 4, and the results of measuring charging/discharging capacity were shown in the following Table 2.

TABLE 2

| | Charge | Discharge |
|---|---|---|
| Cycle Number | Capacity (mAh/g) | Capacity (mAh/g) |
| 1^{st} | 424.7 | 277.9 |
| 2^{nd} | 427.3 | 318.1 |
| 3^{rd} | 406.7 | 393.6 |

As shown in Table 2 and FIG. 4, it could be found that the lithium sulfur battery manufactured according to Example 4, which used the solid polymer electrolyte, worked as a battery.

### EXAMPLE 5

A lithium sulfur battery was manufactured by using the lithium metal negative electrode, the positive electrode manufactured in Example 2 and an electrolyte solution by a common method. As the electrolyte solution, lithium trifluoromethane sulfonate (LiCF₃SO₃) dissolved in tetraethyleneglycol dimethylether (TEGDME) at the molar ratio of 1:4 was used.

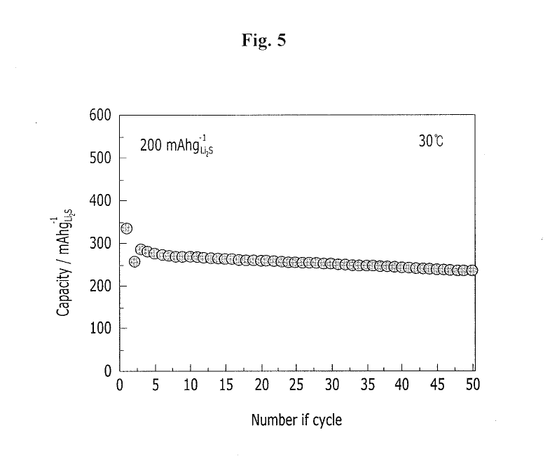

The lithium sulfur battery manufactured in Example 5 was charged/discharged 50 times at 1.0 V to 3.4 V with current of 200 mA/g, and discharge capacities at 3^{rd} cycle and 50^{th} cycle were measured and the results thereof were shown in the following Table 3. Further, capacities according to cycle number were shown in FIG. 5, and the obtained capacity retention rates were shown in the following Table 3.

TABLE 3

| | Cycle Number | | Capacity |
|---|---|---|---|
| | 3 times | 50 times | Retention Rate |
| Discharge Capacity | 286.8 mAh/g | 234.5 mAh/g | 82% |

As shown in Table 3, capacity retention rate was very excellent as 82% even after charging/discharging of 50 times, and therefore, it could be found to be usefully used as a lithium sulfur battery.

While the invention has been described with respect to the above specific embodiments, it should be recognized that various modifications and changes may be made and also fall within the scope of the invention as defined by the claims that follow.

What is claimed is:

1. A positive active material for a lithium sulfur battery comprising:
a core comprising Li₂S; and
a carbon layer formed on the surface of the core.

2. The positive active material for a lithium sulfur battery according to claim 1, wherein the carbon layer is formed with thickness of 10 nm to 500 nm.

3. The positive active material for a lithium sulfur battery according to claim 1, wherein the amount of the carbon layer is 20 wt % to 70 wt %, based on the weight of the core comprising Li₂S.

4. The positive active material for a lithium sulfur battery according to claim 1, wherein the carbon layer is formed with a carbon derived from a carbon precursor selected from sucrose, glucose, pitch, polyvinylpyrrolidone, polyacrylonitrile, or a combination thereof.

5. A lithium sulfur battery comprising:
a positive electrode comprising a positive active material, which comprises: a core comprising Li₂S and a carbon layer formed on the surface of the core;
a negative electrode comprising a negative active material; and
an electrolyte.

6. The lithium sulfur battery according to claim according to claim 5, wherein the carbon layer is formed with thickness of 10 nm to 500 nm.

7. The lithium sulfur battery according to claim according to claim 5, wherein the amount of the carbon layer is 20 wt % to 70 wt %, based on the weight of the core comprising Li₂S.

8. The lithium sulfur battery according to claim according to claim 5, wherein the carbon layer is formed with a carbon derived from a carbon precursor selected from sucrose, glucose, pitch, polyvinylpyrrolidone, polyacrylonitrile, or a combination thereof.
